(19) United States
(12) Patent Application Publication
(10) Pub. No.: US 2018/0325039 A1
(43) Pub. Date: Nov. 15, 2018

(54) DEVICE FOR VERTICAL CULTIVATION OF PLANTS AND METHOD THEREOF

(71) Applicant: Mark Munro Davison, Mosman (AU)

(72) Inventor: Mark Munro Davison, Mosman (AU)

(21) Appl. No.: 15/979,462

(22) Filed: May 15, 2018

Related U.S. Application Data
(60) Provisional application No. 62/506,060, filed on May 15, 2017.

(51) Int. Cl. A01G 9/02; A01G 27/00; A01C 23/04; A01G 24/35; E04H 17/16

(52) U.S. Cl. CPC A01G 9/025; A01G 27/001; E04H 17/163; A01G 27/003; A01G 24/35; A01C 23/042

(57) ABSTRACT

A planting device for cultivating plants is disclosed. The planting device includes a planting panel that further incudes a planting material having properties to absorb and retain water and air. The planting panel includes a mesh metal fence panel, such that, the planting material is molded onto the mesh metal fence panel. Additionally, the mesh metal fence panel includes a soaker hose to dispense water to the planting material and a fertilizer groove to supply nutrient material to the planting material through the dispensed water. The planting device further includes one more vertical supports. The planting panel is attached to the one or more vertical supports, via the mesh metal fence panel, to maintain a steady vertical position.

### BACKGROUND

This disclosure relates generally to cultivating plants and more particularly to device for vertical cultivation of plants and method thereof.

Plants have traditionally been cultivated on land, and soil has been an essential requirement for their growth using tradition cultivation techniques. However, an exponential increase in population and a resultant expansion of infrastructure to support the increasing population has led to scarcity of cultivable land. The infrastructure may include various concrete structure, for example, building, bridges, flyovers, viaducts, overpasses, or roadways, etc.

The problem caused due to scarcity of cultivable land has been solved by a few conventional devices that provide techniques for vertical cultivation of plants without using soil. However, these conventional devices suffer from multifarious drawbacks, which may include: non-aesthetic look, requirement of elaborate containers, frequent maintenance, and high installation and labor cost.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 illustrates a planting panel and a cut-away section 104 of the planting panel in a planting device that enables vertical cultivation of plants, in accordance with an exemplary embodiment.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Like numbers refer to like elements or steps throughout, and prime notation is used to indicate similar elements or steps in alternative embodiments.

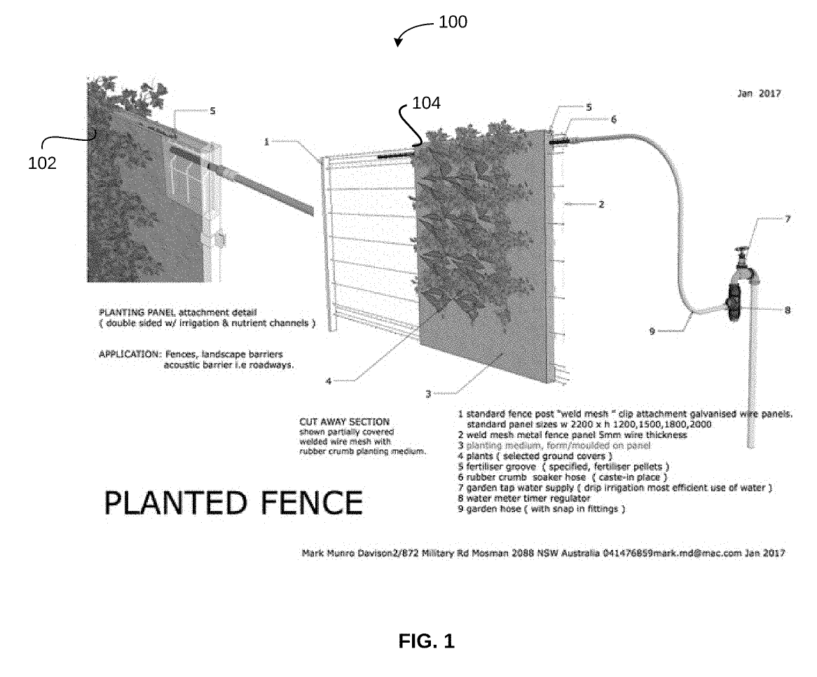

Referring to FIG. 1, a planting panel 102 and a cut-away section 104 of the planting panel 102 in a planting device 100 that enables vertical cultivation of plants is illustrated, in accordance with an exemplary embodiment. The plants for example may include, but are not limited to ground covers and various varieties of grasses. It will be apparent to a person skilled in the art that the planting device 100 is depicted for illustrative purpose only and various other combinations that may form the planting device 100 are within the scope of this invention.

The planting device 100 may be a planted fence as illustrated in FIG. 1, when the planting device 100 is being used as a garden fence. Based on other applications of the planting device 100, structure of the planting device 100 may be modified to suit the application area. Other applications, for example, may include, but are not limited to, sound or acoustic barriers for roadways or industries, and landscape barriers.

The planting panel 102 can be a reinforced homogenous mix of bonded planting materials that form a panel or a fence. By cultivating plants, such as, ground covers and grasses, the planting panel 102 can act as an attractive, visual sound barrier for roadways or as structure for vertical cover of a wall, building, home, or fence, or any other application that can accommodate the planting panel 102. The planting panel 102 can enable growth of plants on both wide sides of the planting panel 102, thereby ensuring efficient utilization of available space and surface area of the planting panel 102.

The cut-away section 104 of the planting panel 102 illustrates various components that form the planting panel 102, in greater detail. The cut-away section 104 depicts a planting material 3 that can be a homogenous mix of bonded and recycled rubber crumb and mineral materials that can have properties to absorb and retain water and air. These mineral material may be natural or may be synthetically manufactured and may aid the planting material 3 in air entrapment and water absorption. An example of the mineral material may include, but is not limited to Vermiculite that is a natural mineral and acts as a fire retardant as well. In an embodiment, while manufacturing the planting material 3, the rubber crumb may be modified by striping of some petrochemicals (for example, oil) and a wash. The planting material 3 can also enable supply of the absorbed water and air to the root zone of cultivated plants 4 in order to support their growth. The use of recycled rubber crumb can ensure that the planting panel 102 is advantageously relatively inexpensive and efficient to manufacture. In an embodiment, the planting material 3 can act as a germination medium, which can be used to cultivate seeds that mature into plants on the planting material 3 itself.

The planting material 3 may be formed or molded on a mesh metal fence panel 2, such that, the planting material 3 may be inseparable from the mesh metal fence panel 2. The mesh metal fence panel 2 can be positioned in the center of the planting material 3 and can act as a reinforced metal mesh for the planting material 3. In an embodiment, the mesh metal fence panel 2 may be formed using wires having a thickness of 5 mm. The mesh metal fence panel 2 with the planting material 3 molded on it, may be supported on one or more vertical supports 1, such as fence posts, that can form the supporting structure for the planting panel 102 and keeps the planting panel 102 steady in a vertical or other desired position. The mesh metal fence panel 2 may either be mounted on the one or more vertical supports 1 or may be attached using various attaching techniques and structures appropriate to accomplish an attaching function. In one embodiment, the one or more vertical supports 1 may be made up of galvanized wire panels of various sizes.

In order to ensure uniform distribution of water for irrigation purpose, a soaker hose 6 can be provided in the planting panel 102. In an embodiment, the soaker hose 6 can pass through the planting material 3 and be caste-in place. The soaker hose 6 may be manufactured using rubber crumb and may be supplemented with a drip feed (not shown in FIG. 1) to ensure uniform distribution of water. Water can be supplied by a garden tap 7 that has a water meter 8 attached to its outlet. The water meter 8 is a time regulator meter, which can ensure that only the requisite amount of water is supplied to the soaker hose 6. In other words, the water meter 8 regulates the water supply to the planting panel 102. The water meter 8 can be connected to the soaker hose 6 via a garden hose 9.

In addition to the regulated supply of water, other nutrient (for example, fertilizers) are also required for healthy growth of the cultivated plants 4. To ensure this, a fertilizer groove 5 can be provided on top of the planting panel 102. The fertilizer groove 5 may be an open channel or groove immediately adjacent to edge surface of the planting panel 102. In an embodiment, the fertilizer groove 5 may be formed in the planting material 3, while molding the planting material 3 on the mesh metal fence panel 2. The fertilizer groove 5 may also be termed as a nutrient reservoir. The fertilizer groove 5 may be formed directly above the soaker hose 6, thus, the nutrients provided via the fertilizer groove 5 may be mixed with water dripping from the soaker hose 6. This ensures a regular, automated, and easy method of irrigation.

The planting device 100 thus provides a simplified method of cultivating plants without the use or need of elaborate containers and thus overcomes complexities of conventional irrigation methods employed in other planted wall systems. The planting panel 102 embodies plants, water, and nutrient as a single homogenous apparatus. Thus, significantly less labor is required to install the planting device 100. Since plant life is embodied as seeds into the planting panel 102 beforehand, there is no need for onsite planting. Moreover, as a result of the soaker hose 6 embodied within the planting panel 102, water loss due to evaporation is advantageously reduced.

While the subject matter has been described in detail with reference to exemplary embodiments thereof, it will be apparent to one skilled in the art that various changes can be made, and equivalents employed, without departing from the scope of the invention.

What is claimed is:

1. A planting device for cultivating plants comprising:
a planting panel comprising:
a planting material having properties to absorb and retain water and air; and
a mesh metal fence panel, wherein the planting material is molded on the mesh metal fence panel.

2. The planting device of claim 1, wherein the mesh metal fence panel comprises a soaker hose to dispense water to the planting material.

3. The planting device of claim 2, further comprising a fertilizer groove to supply nutrient material to the planting material through the dispensed water.

4. The planting device of claim 3, further comprising at least one vertical support, wherein the planting panel is attached to the at least one vertical support via the mesh metal fence panel.

5. The planting device of claim 1, wherein the soaker hose enables regulated and metered irrigation in the planting device.

6. The planting device of claim 1, wherein the fertilizer groove is placed above the soaker hose.

7. The planting device of claim 1, wherein the planting material comprises recycled rubber crumbs.
